(19) United States
(12) Patent Application Publication
(10) Pub. No.: US 2013/0323985 A1
(43) Pub. Date: Dec. 5, 2013

(54) ELECTRICAL CONNECTOR WITH RELIABLE CONNECTION

(71) Applicant: ALLTOP ELECTRONICS (SUZHOU) LTD., Taicang City (CN)

(72) Inventors: Hung-Chi TAI, Jhonghe (TW); Yong-Gang ZHANG, Taicang (CN)

(73) Assignee: ALLTOP ELECTRONICS (SUZHOU) LTD., Taicang City (CN)

(21) Appl. No.: 13/627,486

(22) Filed: Sep. 26, 2012

(30) Foreign Application Priority Data
May 30, 2012 (CN) 201210172396.9

(51) Int. Cl. H01R 24/28

(52) U.S. Cl. 439/660

(57) ABSTRACT

An electrical connector includes an insulative housing and a number of conductive contacts received in the insulative housing. The conductive contacts include a number of first contacts and a number of second contacts. Each first contact includes a first contacting section adapted for contacting with a complementary connector and a first termination section extending beyond the insulative housing. Each second contact includes a second contacting section adapted for contacting with the complementary connector and a second termination section extending beyond the insulative housing. The first contacts are inserted into the insulative housing from one end of the insulative housing, and the second contacts are inserted molded with the insulative housing.

### BACKGROUND OF THE INVENTION

1. Field of the Invention

The present invention relates to an electrical connector, and more particularly to an electrical connector complying with USB 3.0 protocol.

2. Description of Related Art

A conventional USB connector usually comprises an insulative housing, a plurality of conductive contacts accommodated in the insulative housing, and a conductive shell enclosing the insulative housing. The insulative housing further comprises a tongue section with the conductive contacts partially exposed beyond a surface of the tongue section for electrically connecting with a plug connector.

When assembling the conductive contacts to the insulative housing, usually interferential means is adapted for retaining the conductive contacts to the insulative housing. Such interferential means is of low cost and with simple manufacture process, hence, it is widely used for USB connectors. However, when the USB connector mates with the plug connector, the conductive contacts is prone to deviating from original positions thereof, to cause the connection between the conductive contacts and the insulative housing to become unstable, thereafter to influence the electrical connection reliability between the USB connector and the plug connector

Hence, it is necessary to improve the conventional USB connector to address problems mentioned above.

### BRIEF SUMMARY OF THE INVENTION

Accordingly, an object of the present invention is to provide an electrical connector which has reliable connection between conductive contacts and an insulative housing thereof.

In order to achieve the above-mentioned object, an electrical connector comprises an insulative housing and a plurality of conductive contacts received in the insulative housing. The conductive contacts comprise a plurality of first contacts and a plurality of second contacts. Each first contact comprises a first contacting section adapted for contacting with a complementary connector and a first termination section extending beyond the insulative housing. Each second contact comprises a second contacting section adapted for contacting with the complementary connector and a second termination section extending beyond the insulative housing. The first contacts are inserted into the insulative housing from one end of the insulative housing, and the second contacts are inserted molded with the insulative housing.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of an electrical connector in accordance with the present invention;

FIG. 2 is an exploded, perspective view of the electrical connector of FIG. 1;

FIG. 3 is a perspective view of an insulative housing of the electrical connector shown in FIG. 2;

FIG. 4 is a view similar to FIG. 3, but from a different view;

FIG. 5 is a partially assembled view of the electrical connector shown in FIG. 1 with conductive contacts assembled to an insulative housing;

FIG. 6 is a perspective view of the conductive contacts shown in FIG. 5; and

FIG. 7 is a perspective view of an outer shell of the electrical connector shown in FIG. 1.

### DETAILED DESCRIPTION OF THE PREFERRED EMBODIMENT

Reference will be made to the drawing figures to describe the present invention in detail, wherein depicted elements are not necessarily shown to scale and wherein like or similar elements are designated by same or similar reference numeral through the several views and same or similar terminology.

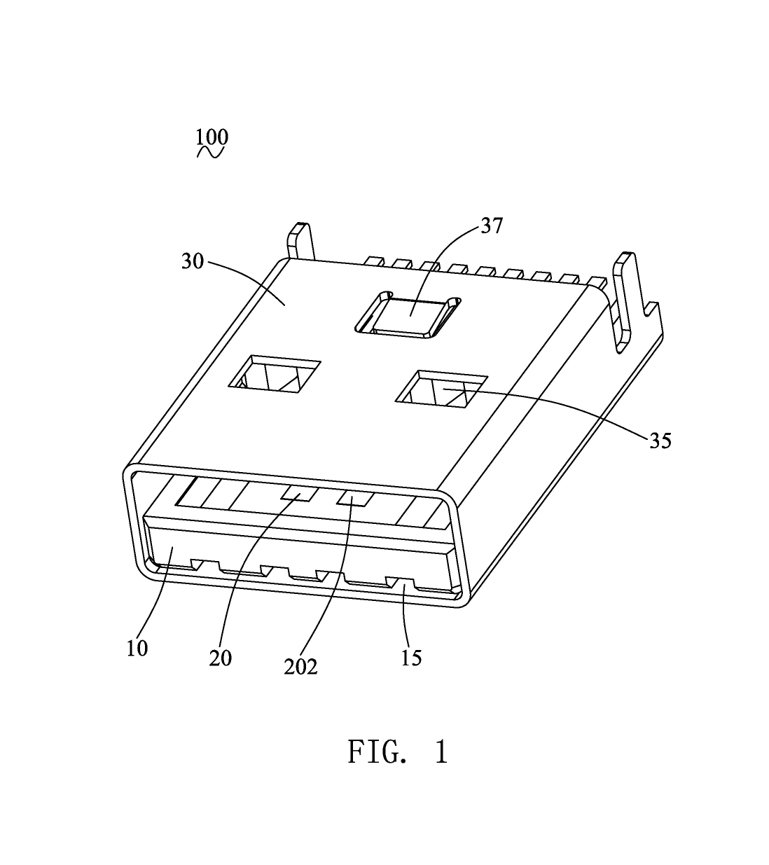

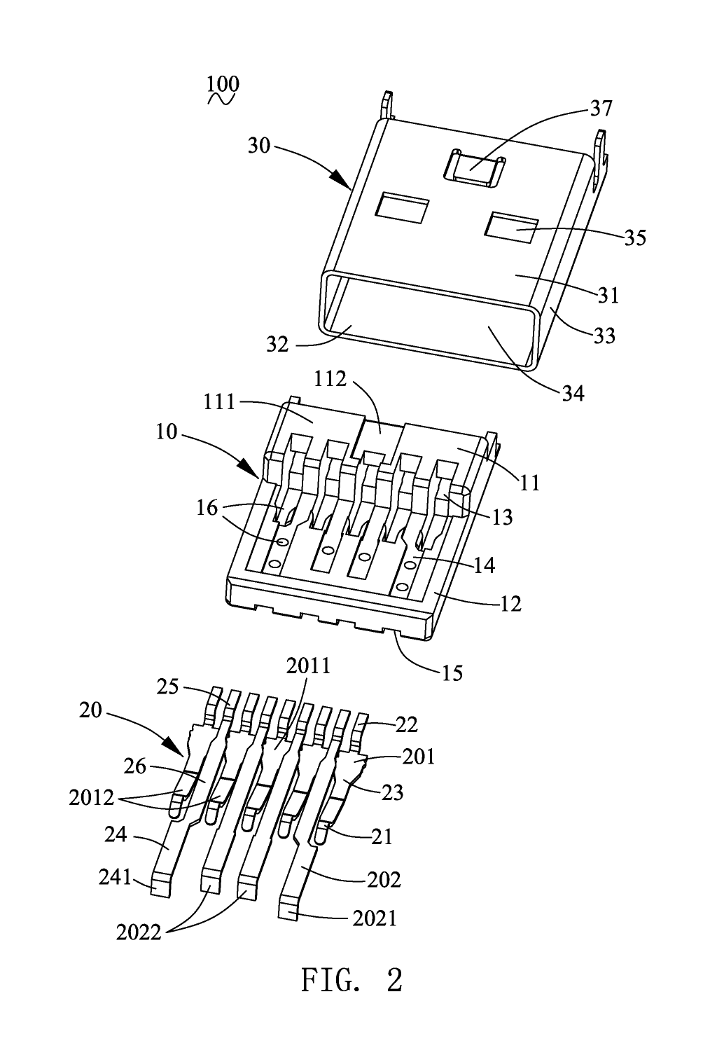

Referring to FIGS. 1-2, an electrical connector 100 in accordance with the present invention comprises an insulative housing 10, a plurality of conductive contacts 20 retained in the insulative housing 10, and an outer shell 30 enclosing the insulative housing 10 and the conductive contact 20. The conductive contacts 20 comprise a plurality of first contacts 201 and a plurality of second contacts 202 alternatively disposed with the first contacts 201. Further, the first contacts 201 are inserted into the insulative housing 20 from one end of the insulative housing 10, while the second contacts 202 are insert molded with the insulative housing 10.

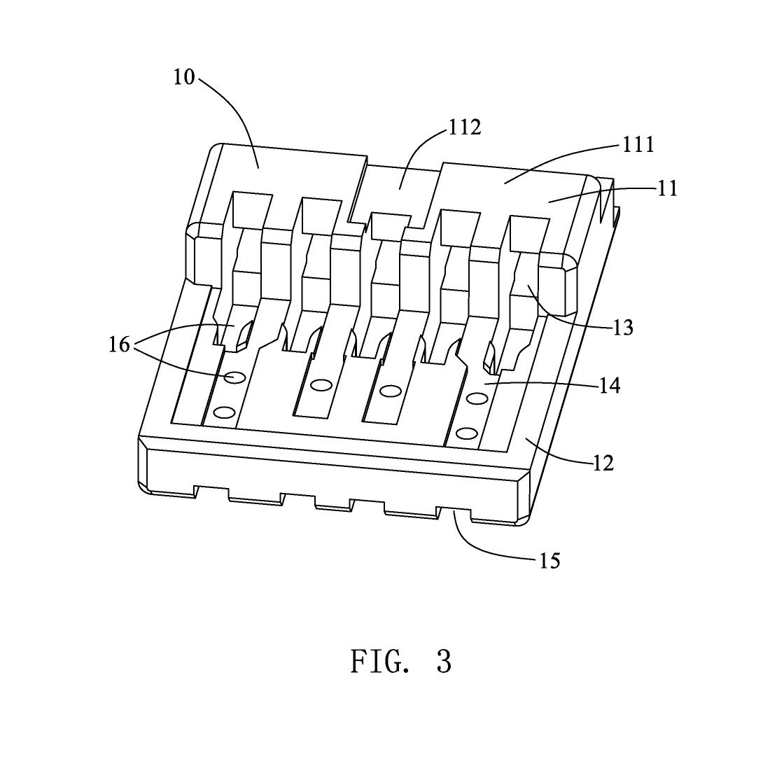

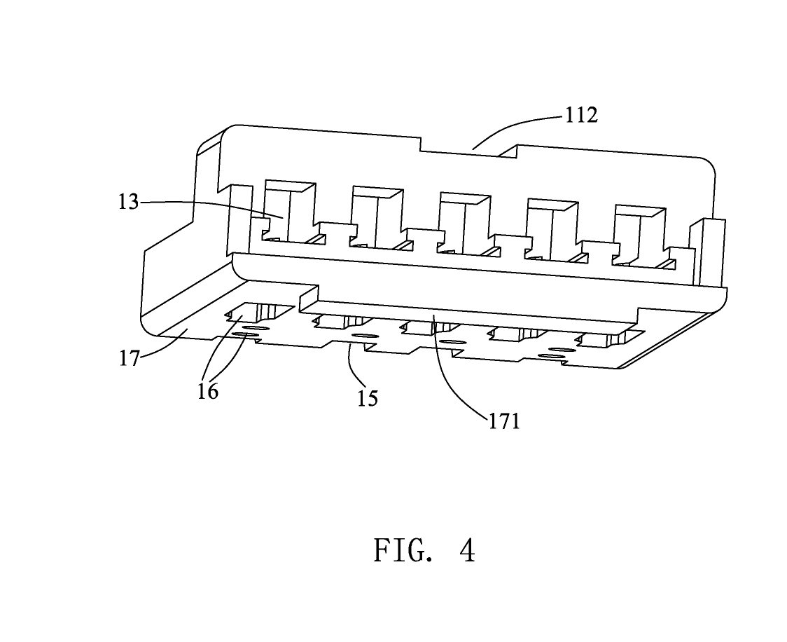

Please refer to FIGS. 3-4 in conjunction with FIG. 2, the insulative housing 10 comprises a main portion 11 and a mating portion 12 extending forwardly from the main portion 11. The insulative housing 10 also defines a plurality of first receiving slots 13 and a plurality of second receiving slots 14 for receiving the conductive contacts 20. In the preferred embodiment of the present invention, since the configuration of the first contact 201 is different from that of the second contact 202, the configuration of the first receiving slot 13 is also different from that of the second receiving slot 14.

The first receiving slot 13 penetrates through the main portion 11 of the insulative housing 10 along the insertion direction of the first contact 201, and the second receiving slot 14 extends from a rear edge of the main portion 11 till the mating portion 12 along the extending direction of the second contact 202. The mating portion 12 defines a plurality of recesses 15 communicating with corresponding second receiving slots 14 in the front end thereof. The recess 15 recesses rearwardly and upwardly from a front surface of the mating portion 12 and extends along the insertion direction of a complementary plug connector (not shown). The mating portion 12 also defines a plurality of holes 16 communicating with the first and second receiving slots 13, 14 and penetrating through the mating portion 12. Via the cooperation between the holes 16 and the first and second contacts 201, 202, the heat generated by the first contacts 201 in the first receiving slots 13 and the heat generated by the second contacts 202 in the second receiving slots 14 is capable of being radiated out in time, and also the status of the first and second contacts 201, 202 could be monitored through the holes 16.

In the preferred embodiment of the present invention, the main portion 11 defines a notch 112 recessed downwardly from an upper surface 111 thereof for cooperating with the outer shell 30, and a bar 171 protruding downwardly from an opposite lower surface 17 thereof for cooperating with the outer shell 30.

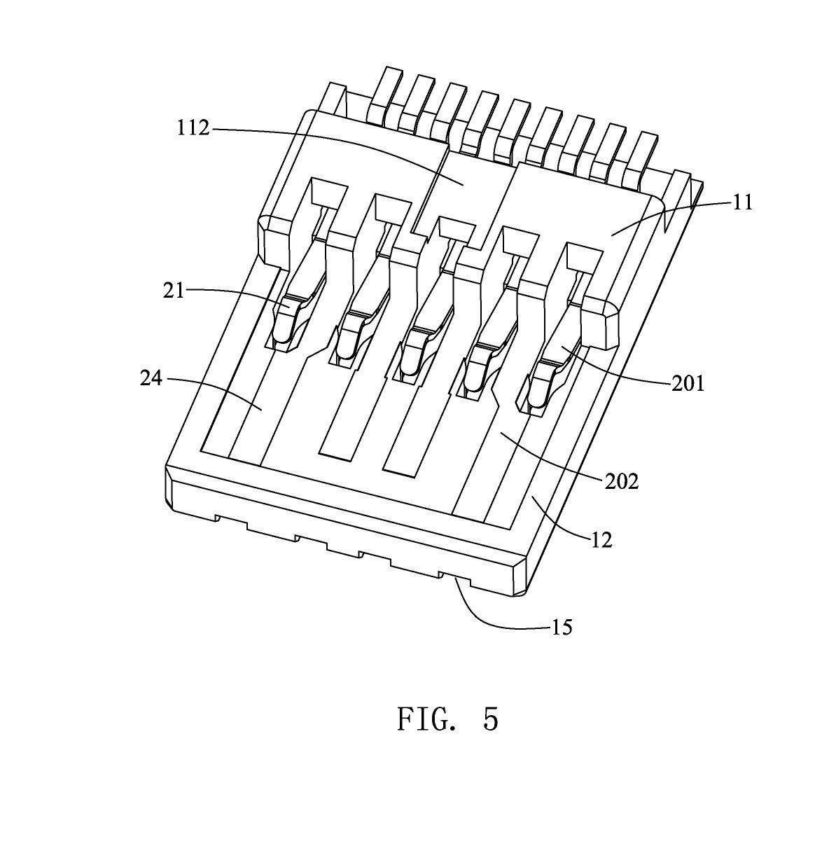

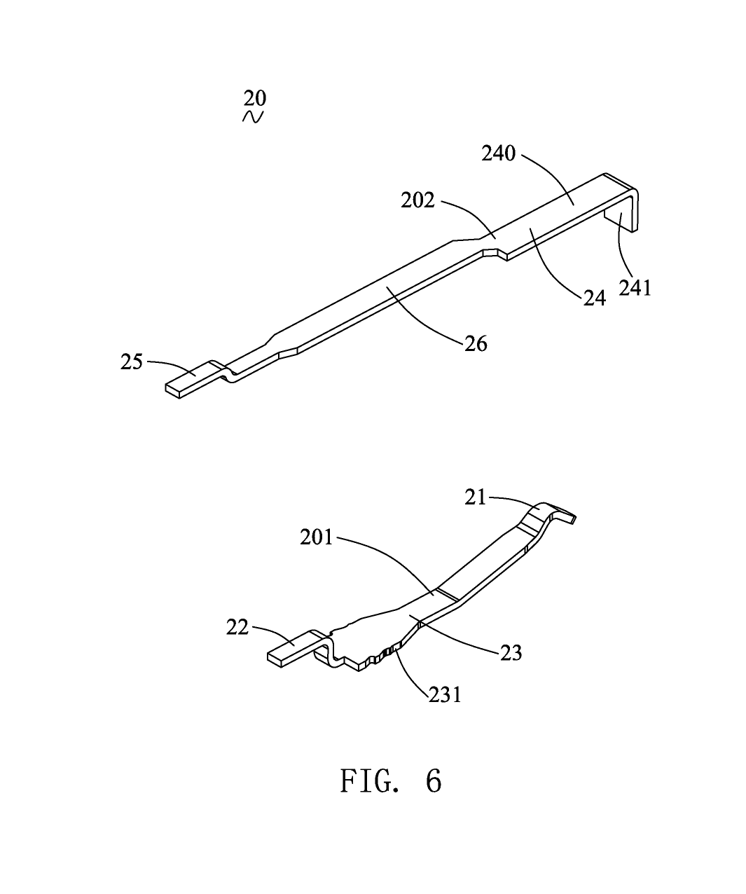

Referring to FIGS. 5-6, the first contacts 201 comprise a middle first ground contact 2011 and two pairs of first differential pair 2012 located at opposite sides of the first ground contact 2011. The second contacts 202 comprise a second differential pair 2022 and a pair of second ground contacts 2021 located at opposite outer sides of the second differential pair 2022. In summary, the arrangement of the contacts 20 complies with the interface protocol of USB 3.0. The first contact 201 comprises a first contacting section 21, a first termination section 22 and a first intermediate section 23 connecting the first contacting section 21 and the first termination section 22. The second contact 202 comprises a second contacting section 24, a second termination section 25 and a second intermediate section 26 connecting the second contacting section 24 and the second termination section 25. The second contacting section 24 is of L-shape and comprises a longer flat section 240 and a shorter retaining section 241 bending downwardly from the flat section 240.

The first contacting section 21 is curved and elastic, while the second contacting section 24 is flat and non-elastic. The first contacting section 21 is closer to the main portion 11 of the insulative housing 10 than the second contacting section 24. Roughly, the free end of the first contacting section 21 is located behind a rear end of the second contacting section 24. In the preferred embodiment of the present invention, the first and second contacting sections 21, 24 are both located at the same side of the mating portion 12 and exposed to the outside. The first intermediate section 23 and the second intermediate section 26 are respectively located in different horizontal surfaces arranged along a thickness direction of the insulative housing 10. The first and second termination sections 22, 25 respectively bend from the first and second intermediate sections 23, 26 and locate in the same surface. The retaining sections 241 are respectively received in the recesses 15. The first intermediate section 23 forms a plurality of barbs 231 on opposite lateral sides thereof. Via the interferential engagement between the barbs 231 and the first receiving slots 13, the first contacts 201 are reliably retained in the first receiving slots 13. Especially, the first contacts 201 are inserted into the first receiving slots 13 after the second contacts 202 are insert molded with the insulative housing 10.

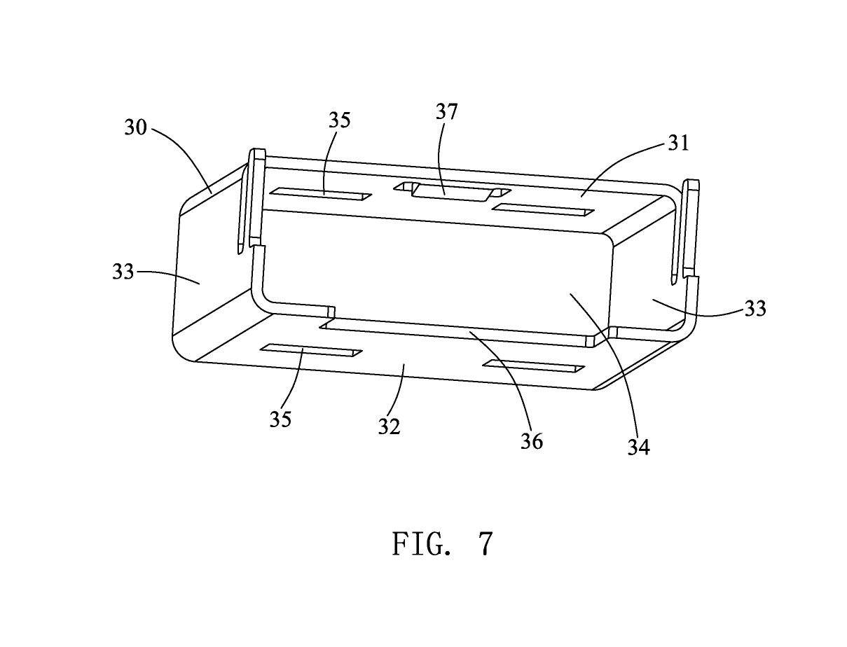

Turning to FIG. 7 in conjunction with FIG. 2, the outer shell 30 comprises an upper wall 31, a lower wall 32 opposite to the upper wall 31 and a pair of lateral walls 33 connecting the upper wall 31 and the lower wall 32. A receiving space 34 is defined by the upper wall 31, the lower wall 32, the lateral walls 33 and the insulative housing 10 for receiving the complementary plug connector. The upper wall 31 and the lower wall 32 respectively define a pair of latching notches 35 for cooperating with the complementary plug connector. The lower wall 32 forms a cutout 36 for interferentially receiving the bar 171. The upper wall 31 forms a latching tab 37 to cooperate with the notch 112. Via the engagement between the bar 171 and the cutout 36, and the engagement between the latch tab 37 and the notch 112, the insulative housing 10 is prevented from being moved relative to the outer shell 30 along the length direction, the width direction and the height direction, thus enhancing the reliable electrical connection between the electrical connector 100 of the present invention and the complementary plug connector. Further, the first and second contacting sections 21, 24 are exposed into the receiving space 34 and face to the upper wall 31.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. An electrical connector, comprising:
an insulative housing;
a plurality of conductive contacts received in the insulative housing and comprising a plurality of first contacts and a plurality of second contacts, each first contact comprising a first contacting section adapted for contacting with a complementary plug connector and a first termination section extending beyond the insulative housing, each second contact comprising a second contacting section adapted for contacting with the complementary plug connector and a second termination section extending beyond the insulative housing, wherein the first contacts are inserted into the insulative housing from one end of the insulative housing, and the second contacts are inserted molded with the insulative housing.

2. The electrical connector as claimed in claim 1, wherein the free end of the first contacting section of the first contact is behind a rear end of the second contacting section of the second contact.

3. The electrical connector as claimed in claim 2, wherein each second contacting section of the second contact is of L-shape and comprises a flat section embedded in the insulative housing and a retaining section bending vertically from the flat section.

4. The electrical connector as claimed in claim 3, wherein the insulative housing defines a plurality of recesses recessed upwardly and rearwardly from a front surface thereof, wherein said retaining sections of the second contacting sections of the second contacts are received in the recesses.

5. The electrical connector as claimed in claim 1, wherein the insulative housing comprises a main portion and a mating portion extending forwardly from the main portion, wherein the first and second contacting sections of the first and second contacts are located at the same side of the mating portion of the insulative housing and exposed to the outside.

6. The electrical connector as claimed in claim 5, wherein the first contacting section is curved and elastic, and the second contacting section is flat and non-elastic, wherein the first contacting section is located closer to the main portion of the insulative housing than the second contacting section.

7. The electrical connector as claimed in claim 1, wherein the first contact comprises a first intermediate section connecting the first contacting section and the first termination section, and the second contact comprises a second intermediate section connecting the second contacting section and the second termination section, wherein the first and second intermediate sections are located in different horizontal surfaces arranged along a thickness direction of the insulative housing.

8. The electrical connector as claimed in claim 7, wherein the first and second termination sections bend from respective first and second intermediate sections and are located in the same surface.

9. The electrical connector as claimed in claim 1, wherein the first contacts comprise a first ground contact and two pairs of first differential pair, and the second contacts comprise a pair of second ground contacts and one pair of second differential pair.

10. The electrical connector as claimed in claim 1, wherein the insulative housing defines a plurality of first and second receiving slots to receive the first and second contacts, and a plurality of holes penetrating through the insulative housing and communicating with the first and second receiving slots for radiating the heat generated by the first and second contacts.

11. The electrical connector as claimed in claim 1, further comprising an outer shell enclosing the insulative housing and conductive contacts.

12. The electrical connector as claimed in claim 11, wherein the outer shell comprises an upper wall, a lower wall and a pair of opposite walls connecting the upper and lower walls, wherein the first and second contacting sections of the first and second contacts face to the upper wall.
